(19) United States
(12) Patent Application Publication
(10) Pub. No.: US 2021/0266170 A1
(43) Pub. Date: Aug. 26, 2021

(54) System and method of trustless confidential positive identification and de-anonymization of data using blockchain

(71) Applicant: Antonio Rossi, Rome (IT)

(72) Inventor: Antonio Rossi, Rome (IT)

(21) Appl. No.: 17/186,324

(22) Filed: Feb. 26, 2021

Related U.S. Application Data
(60) Provisional application No. 62/981,823, filed on Feb. 26, 2020.

(51) Int. Cl. H04L 9/32; G06F 21/62; H04L 9/00

(52) U.S. Cl. CPC H04L 9/3231; H04L 9/3236; G06F 21/6254; H04L 2209/38; H04L 9/008; H04L 2209/04; H04L 9/3218

(57) ABSTRACT

A system and method for enrollment and matching of a positive biometric identification belonging to an individual that has a biometric template of the individual cryptographically encrypted and masked to others. Data relating to the individual can be connected to the biometric identification in a way that others may access the data without being able to identify the individual or access the biometric template; hence privacy is preserved. The biometric template is completely controlled by the individual in the sense that the data is available and anonymized, but can only be de-anonymized by the individual.

This application is related to, and claims priority from, U.S. Provisional Patent Application No. 62/981,823 filed Feb. 26, 2020. Application 62/981,823 is hereby incorporated by reference in its entirety.

### BACKGROUND

### Field of the Invention

The present invention relates generally to the field of data, and more particularly to a system and method of confidential positive identification of anonymized data.

### Description of the Problem Solved

The big data industry needs ways to acquire data and ways to analyze data. Many people focus solely on data analysis technology, but the difficult challenge in big data is acquiring the data, even more so in fields covered by regulations and laws protecting the privacy of individuals. Often the more valuable data is related to people and their privacy (see for example the article of Neil M. Richards and Jonathan H. King “Big Data Ethics”).

Information blocking is also an obstacle to data acquisition, for example in the healthcare industry. Information blocking is described as the result of “an unreasonable constraint imposed on the exchange of patient data or electronic health information”. Information blocking might be also related to is some measure to medical errors, identified as an unintended act (either of omission of commission) or one that does not achieve its intended outcome, when a patient misidentification is involved. Misidentification in turn may include a duplicate or overlaid medical record, identity theft, or the like. According to the American Health Management Association, the average duplication rate in a healthcare organization is between 8 and 12 percent.

It would be advantageous to have a system that relates to two conflicting objectives, on one side there is a need to add privacy and protection of personal data; meanwhile on the other side, there is a need to securely associate the same data to the right individual. The solution of the conflict can bring certainty and agility to data, it exploits data usage as well for secondary purposes in research.

### SUMMARY OF THE INVENTION

The present invention relates to a system and method for enrollment and matching of a positive biometric identification belonging to an individual that has a biometric template of the individual cryptographically encrypted and masked to others. Data relating to the individual can be connected to the biometric identification in a way that others may access the data without being able to identify the individual or access the biometric template; hence privacy is preserved. The biometric template is completely controlled by the individual in the sense that the data is available and anonymized, but can only be de-anonymized by the individual.

The biometric template can be referenced by a hash string obtained through a one-way pre-image resistant cryptographic function. The hash string is immutably stored into a trustless decentralized ledger distributed multiple times to a plurality of nodes exchanging consensus over a blockchain. Biometric matching can be proved through a privacy-preserving calculation without disclosing the biometric template to third parties. Typically, the data can be stored by a data custodian outside the blockchain, and the data custodian can use the data for secondary purposes such as research or data mining without learning the identity of biometric template of the data originator.

### DESCRIPTION OF THE PREFERRED EMBODIMENTS

Before the present invention can be understood in detail, certain background information about the technology must be presented.

### Data Anonymization and De-Identification

Data anonymization is the process of protecting private or sensitive information by erasing or concealing identifiers that connect an individual to stored data. As of today, many governments outline a specific set of rules that protect user data, such as the General Data Protection Regulation in the EU (GDPR). Even though the GDPR is strict, companies are allowed to process data without consent (and store it indefinitely) if personally identifiable information (PII), is removed or hidden from the data.

### Personal Identifiable Information (PII) and Quasi Identifiers

PIIS comprises name, age, gender, state, religion, government issued ID, biometric measurements, and the like. In a dataset used for artificial intelligence (AI), more specifically machine learning and its subcategories (i.e. Deep Learning), these data must typically be unlinked from the individuals due to privacy concerns. A second type of features may be attributed to more than one individual and are termed quasi-identifiers (QI), such as age or gender of a group of individuals.

QIs are typically believed to not compromise privacy and are typically considered not-privileged PII. However, it has been demonstrated that if used in combination with other QIs, query results, and external information, it may be possible to re-identify an individual (see “A Systematic Review of Re-Identification Attacks on Health Data” from Khaled E; Emam et al.). Nevertheless, machine learning represents a powerful and useful statistical technique; its effectiveness depends largely on the availability of great amount of information to train models of prediction. The present invention provides ways to handle this data without compromising the identity of individuals.

### Data Masking

Data masking is one of the most used technique for achieving anonymization. In a typical embodiment, an encrypted record is created in which data are unintelligible for unauthorized subjects not able to decipher the content. In the context of privacy legislation, anonymization aims at de-identification of individuals by removing or hiding PII in the data. De-identification allows disclosures for secondary purposes, such as using health records for research without the need of obtaining consent or authorization from patients before disclosure. However de-identification is real anonymization only if identifiable information cannot be decrypted or retrieved by a data custodian, otherwise one only has pseudo-anonymization.

### Data Custodian

A data custodian is someone or entity that controls the procedures and purpose of data usage and can process the information by itself or delegate processing to third parties. In the present invention, the individual is in control of the encryption key that is masking his PII, meanwhile data custodians, and any other entity, cannot link back to the same individual that is controlling the encryption key. This results in achieving permanent anonymization.

### Biometrics and Positive Recognition

Biometric identifiers are body measurements and calculations related to the human characteristics of an individual, for example a fingerprint, face, iris recognition, DNA, or the like. Biometric identification is a two-step process of enrollment and matching. In the first step of the process, an individual performs the enrollment by allowing the capturing and storing of his or her biometric information as a template for later retrieval and usage in a matching phase. The matching phase is where the biometric template is used for comparison with a new biometric measurement in order to prove the identity of the individual—the subsequent identification phase.

These two steps can further include other sub-tasks, for example the removal of artifacts that might be introduced by the acquisition sensor; the usage of some kind of normalizations for extracting the desired features from measured data; the usage of specific algorithms for performing the comparison between stored vs. newly acquired data and the like.

Biometric systems may vary in accurateness and complexity. Multiple sensors or biometrics can be implemented for complementing measurements of an individual and overcome compromising of data, for example due to aging of the individual themself.

Biometric systems are also characterized by performance metrics, such as the false match rate (FMR) measuring the probability that the system incorrectly matches the input pattern to a non-matching template or the false non-match rate (FNMR) that is the probability that the system fails to detect a match between the input pattern and a matching template in the database, etc.

Positive identification of data might be required by third parties; for example this is highly desired in the healthcare industry where the correct care needs to be delivered to the correct patient. Some advanced solutions provide positive recognition by using biometric identification to create 1:1 proof of ownership between patients and their records (see Imprivata Inc. in the US). Biometric identification is generally used in all cases where other method of identification such as password, PINs or the possess of encryption keys are deemed ineffective; where positive recognition is a means to prevent multiple people from using the same identity.

However biometric data are a form of PII and cannot be freely in possession of a data custodian if they can be associated with anonymized data in order to perform a step of de-identification and proof of ownership of the data. The simple possess by a data custodian of biometric data linking to an anonymized record implies that the anonymization is not anymore in effect. Furthermore, since most biometric features could disclose physiological and/or medical conditions, for example fingerprint patterns are related to chromosomal diseases (see for example “Roles of Dermatoglyphics in Medical Disorder” of J. Kaur et al.), data-related to biometric measurements may be used in many illicit ways, without the individual consent.

Advantageously in the present invention the biometric template is controlled by the individual to whom the anonymized data pertain; meanwhile he is able to provide biometric matching, and positive recognition, demonstrating the association established in the past with the anonymized data. In the present invention the biometric template is cryptographically hidden and entangled with the anonymized data.

The present invention has multiple pieces that must be orchestrated: anonymized data, encrypted biometric templates, encryption keys, plus optionally encrypted PII, QIs and metadata, plus timestamps to be assigned with certainty. There is also the need of adding robustness and structure to all this information, of consistently organize and protect everything from tampering; the need of adding certainty and immutability to records.

### Blockchain

A blockchain is, as devised originally by its inventor, a time-stamped series of immutable record of transactions that is managed by an open cluster of computers not owned by any single entity; each of the computers running within the cluster owning a copy of data synchronized to others by using a protocol of consensus. The protocol of consensus guarantees a common truth and rejects malicious writes and attempts to corrupt the shared data. Non-trusting entities with write privileges can agree on the consistency of the distributed ledger.

A transaction on a blockchain is an atomic event that is allowed by the protocol. It might resemble a financial transaction, i.e. Bob send Alice 1 coin, or something else. A transaction is created by the controller of a private key; meanwhile the component used by an individual or an entity for generating transactions is commonly termed a wallet.

### Assets

Entities transacted are termed blockchain assets, or more generally digital assets. A blockchain asset may be a digital representation of some form of money (crypto currency), or can be a digital representation of stakes in a particular project or company or the like. In the present invention, blockchain assets comprise the digital representation of a relation among sparse pieces of data that pertain to a wallet owner independently from where and how the data are stored. Also, some data itself can be stored on the blockchain and therefore are blockchain assets.

### Visibility of Information on the Distributed Ledger

The original blockchain is also largely transparent; almost all information is clearly visible, so one can track for example receiving and sending addresses, transactions details comprising amounts transacted, balances of addresses and other metadata. Once again this is different for the private keys originating transactions and controlling public addresses. Private keys must be kept strictly confidential by a wallet owner.

For fixing the lack of privacy in the first blockchain, many variations have been derived from the original teaching in which the confidentiality is managed at various levels, being always the persistent and common attribute the immutability. The immutability of the blockchain is immutable in any variation of the technology and aims to protect data, the distributed ledger, from tampering.

### Private Confidential Chains

Many solutions provide different grades of confidentiality for data that are being managed by a blockchain. In cases in which nodes need to obtain permission to participate in the cluster, a consortium, we have the category of permissioned blockchains. The confidentiality and the protection of the information in a permissioned blockchain is enforced at the infrastructure level. A permissioned blockchain may be required for compliance with laws and directives of some jurisdictions or regulatory entities who denies the use of open clusters in total or in part in certain sectors. In one embodiment of the present invention for which constraints of the above type are present, the immutability of the data may be served by a permissioned blockchain.

### Cryptographically Confidential Chains

More sophisticated solutions for achieving confidentially in a distributed ledger involve cryptography. In these embodiments, the confidentiality of a transaction is substantially given by mathematics applied to computer science. In these blockchains, the transactions and the blockchain assets can be completely shielded under the control of the private key owner. Also, the addresses involved in a transaction, likewise the transaction itself, can be hidden. Moreover, when a zero-knowledge protocol is part of the implementation, the owner can prove the possession of a certain information to anyone else without revealing the information itself. The part of a transaction that can be selectively disclosed, or proved, is commonly defined with the term note. A zero-knowledge protocol is a proof system, basically, a proof system is involving two parties, a prover and a verifier. More on that later. It is also a discretionary power of the wallet owner, the prover, to selective disclose content of a note by distributing an appositely generated viewing key to third party, a verifier. Exemplary implementations of this kind of technology are for example the ZCash blockchain or the ATZEC protocol running over the Ethereum blockchain.

### Protecting Malicious Changes to Data Outside a Blockchain

A cryptographic hash function must be able to withstand all known types of cryptoanalytic attack. It is a mathematical algorithm that maps data of arbitrary size (often called the “message”) to a bit string of a fixed size (the “hash value”, “hash”, or “message digest”) and is a one-way function, that is, a function which is practically infeasible to invert. In information-security contexts, cryptographic hash values are sometimes called digital fingerprints, checksums, or just hash values. In the context of a blockchain, the transactions are taken as an input and run through a hashing algorithm (Bitcoin uses SHA-256) which gives an output of a fixed length. This means that no matter how many times one parses through a particular input through a hash function, one will always get the same result.

Hashes have pre-image resistance, a property stating that given hash H(A) it is infeasible to determine A, where A is the input and H(A) is the output hash. Moreover, if one makes a small change in the input, the changes that will be reflected in the hash will be huge. A typical usage of cryptographic hashes is to provide a chain of trust and detect malicious changes to hashed objects (i.e. files).

### Masking Personal Identifiable Information in Data

The discovery of tools such as RSA cryptography and elliptic curve cryptography were major advances in cryptography. More recently, zero-knowledge cryptography represents a similarly fundamental development in the field, and is well suited for use with blockchain. Other technologies of data masking are more particularly oriented towards a different set of use cases, for example steganography and homomorphic encryption. They can also be advantageously used in the present invention.

### Steganography

Steganography in the digital world is the practice of concealing a file, message, image, or video within another file, message, image, or video. Whereas cryptography is the practice of protecting the contents of a message alone, steganography is concerned both with concealing the fact that a secret message is being sent and protecting its contents. Steganography can be used in combination with encryption, for example by masking the secret part inside a file by using a shared secret such as a password only known to involved parties, for later retrieval.

### Homomorphic Encryption

Homomorphic public-key cryptography (hPKC) was disclosed by Ishai et al. in the white paper titled “Efficient Arguments without Short PCPs” (the designated verifier case) and Groth in the white paper titled “Short Pairing-based Non-interactive Zero-Knowledge Arguments” (the publicly verifiable case). In highly regulated industries, such as health care or finance, homomorphic encryption can be used to enable new services by removing privacy barriers inhibiting data sharing and allowing outsourcing of information to commercial cloud environments for research and other secondary data-sharing purposes.

Homomorphic encryption makes it possible to analyze or manipulate encrypted data that are masked through usage of asymmetric keys, without revealing the data to anyone; it is valuable in areas with sensitive personal data such as in financial services or healthcare. Like other forms of public encryption, homomorphic encryption uses a public key to encrypt data and allows only the individual with the matching private key to access its unencrypted data (though there are also examples of symmetric key homomorphic encryption as well). Homomorphic encryption can protect the sensitive details of the actual data, but still allow analysis and processing without jeopardizing privacy because data remains encrypted while it's being processed and manipulated. The original homomorphic encryption provides the operations of adding and multiplying in bits. This suffices to have Turing completeness and to enables any useful operation that a computer is capable of (see for example “Improved Delegation of Computation Using Fully Homomorphic Encryption” of Kai-Min Chung et al.).

### Privacy Preserving Calculation

An exemplary application of homomorphic encryption is used in Crypto-Nets. The data owner encrypts the data and sends the ciphertexts to a third party to obtain a prediction from a trained model (machine learning model); for example, a hospital using a patient's medical record. The model operates on these ciphertexts and sends back the encrypted prediction. In this protocol, not only the data remains private, but even the values predicted are available only to the data owner (see Crypto-Nets: Neural Networks over Encrypted Data of Pengtao Xie et al.).

Another relevant example is given by Numerai (https://numer.ai), a company sharing expensive proprietary financial data with experts of machine learning algorithms, data scientists, and the like, for seeking to devise and build advanced prediction models on the stock market. Numerai has not danger of sharing its valuable information because it is masked using homomorphic encryption. The same happens for the results (predictions) returned by models developed on the encrypted data; they are encrypted too, and only known to Numerai.

### Other Approaches to Privacy Preserving Calculation

Homomorphic encryption calculations are slow, even using the cloud and specialized processing resources such as GPUs (see “Exploring the Feasibility of Fully Homomorphic Encryption” of Wei Wang et al.). Additional form of privacy preserving calculation technologies other than homomorphic encryption are well-known and also widely used.

Trusted execution environments (TEE) are a specialized and isolated area on a processor that is separate and not executing the main operating system. Instead confidential code is run in a secure enclave, a black box where the state of the program is completely hidden and inaccessible to anyone. A keypair generated within a TEE allows encryption of data with the public key making execution on the data only possible inside the secure enclave.

Secure Multi-party Computation (sMPC) instead is a cryptographic technique that performs a confidential computation by splitting data in multiple pieces distributed among participants in the scheme so to allow computation to be executed without anyone knowing the original data. The only way to expose the original data is for every node to collude.

Finally, there is the aforementioned zero-knowledge, a cryptography technique that can attest the validity of a statement, i.e. the correctness of a program execution on certain data, without revealing the data itself.

Any form of privacy preserving calculation, or a combination of them, can be chosen in the present invention. A strong evolution is occurring in the field among competing schemes, and drawbacks existing today can be reduced or eliminated by advancements and mutate the trade-offs being evaluated.

### Sparse Anonymous and Masked Data

In the present invention anonymized data are stored somewhere, it hardly matters where; it can even be stored in a distributed file system such as the Interplanetary File System (IPFS). What matters is that they are either anonymized or masked and both unambiguously identified and retrievable, for example by using a Uniform Resource Identifier (URI).

This data pertains to an individual, and is acquired and associated with a Cryptographically hidden biometric template; the association demonstrably shown in an ensemble identifier where the ensemble identifier is stored on a blockchain for preventing malicious changes and obtaining a timestamp. Each piece of the ensemble, a file, is identified by the retrieving the identifier of the file plus the hash of the file, so an ensemble is composed by a list of retrieving identifiers and a list of hashes. The ensemble identifier needs additional properties, such as to be protected from falsification, or to be effective in avoiding the possibility of being duplicated and used by a malicious actor in a discovery phase.

### Ensemble Identifier Commit and Reveal

The ensemble identifier can be calculated by taking in a first step, a master hash of the hash list as it happens in the BitTorrent protocol. In a second step, the master hash is combined with a secret controlled by the wallet owner such as a password or a randomly generated nonce, and finally, the hash of this further combination will be the value stored as the ensemble identifier on the blockchain. This is a well-known technique named the commit/reveal scheme that allows one to commit to a chosen value while keeping it hidden to others.

To reverse the process (the positive disclosure), these steps may be performed:

1. The wallet owner discloses the list of retrieving identifiers for the files composing the ensemble comprising the encrypted biometric template and the anonymized data.

2. Each file is downloaded, and the hash is calculated for any single file.

3. The master hash is obtained by combining the hashes previously obtained.

4. The wallet owner discloses the secret that must be used in combination with the master hash for generating the ensemble identifier stored in the blockchain in a past time.

5. The wallet owner decrypts the biometric template to make it possible to execute a positive recognition in the biometric match.

When the positive disclosure above is completed, the anonymous data is de-anonymized but there is the inconvenience that the secret was disclosed in step 4 and the biometric template is shown unencrypted in step 5. Advantageously in the present invention, the wallet owner performs steps 4 and 5 above in the positive disclosure without compromising the secret or showing an unencrypted biometric template.

### Storage On/Off Chain

From a technical perspective, there is no a constraint in storing all the data on the blockchain; however, this can be too expensive in storage and computation resources. It would suffice to store the ensemble identifiers immutably on a distributed ledger to avoid tampering. Anyway, other form of constraints, such as regulations or limits related to the possibility of running code involving external data on a blockchain, may impose a constraint to also store data itself on the blockchain. The anonymous part of data that have been anonymized to third parties, acting as data custodians, can freely be used for secondary purposes without anyone being able to link back to the individual.

### Proof

A proof is given when a prover demonstrates to a verifier that a statement is valid, and the proof is characterized by two important properties: completeness and soundness. Completeness is the ability of a prover to convince a verifier of a valid proof, so a hash stored in combination with an URI in a blockchain, or a combination of multiple hashes and URIs stored in a distributed ledger (an ensemble identifier) is a proof that the data was acquired in a certain time in the past and can be checked for integrity. It is to be noted that even if data are moved or copied, the hash of the file doesn't change. The second property in a proof system is the soundness; there is soundness when everything that is provable is in fact true. Perfect soundness consists in the ability of the verifier to always refuse invalid proofs.

However perfect soundness in not always necessary or possible. In proof systems that are based on computation, there could be bounds limiting the availability of resources and a requirement of relaxing the constraints of perfect soundness. We have instead computational soundness, widely used, when a verifier is highly unlikely to accept an invalid proof. More generally, the prover constructs a proof where a particular statement (denoted as φ) and some additional information, referred to as a witness w, belong to a certain relation R, namely (φ, w)□R.

### Argument

A valid proof generated by a proof system that has perfect completeness and computational soundness is referred to as an argument, and its robustness is based on the fact that if technical bounds are present they impact both parties: the prover and the verifier, so that a computationally bounded prover is unlikely to fool a verifier. The condition of potentially accepting invalid arguments is present in most cryptographic techniques. For example, it is well known that an adversary able to factorize large primes can break RSA cryptography. For this reason, proof systems with computational soundness are characterized by probabilistic statements about their robustness; for example, given a certain computation bound, an adversary would take longer than the age of the universe to randomly guess the private information needed to generate a valid proof.

### Succinctness

A proof system can also have succinctness allowing for fast and efficient computations by the verifier. Meanwhile the algorithm for generating the proof can require significant time and computational resources from the prover. When these conditions exist, the proof output is said to be succinct, and the verification is rapid on the verifier side. A computationally limited verifier can outsource a complex calculation to an external system or to the cloud, and easily verify the returned succinct proof. Succinctness is relevantly important on the blockchain where storing information and running verification algorithms is expensive.

### Interactive and Non-Interactive Proof

The interaction between the prover and the verifier can involve multiple exchanges and communications of multiple proofs or, more efficiently, the interaction can consist of a single step of the prover generating a single exhaustive proof and making it available to the verifier. In the second case, the non-interactive argument given in just a single message from the prover to the verifier is ideal for submitting to a blockchain where the verifier can perform his operations and either accept or reject the proof. The acronym SNARG defines this technology; it stands for “succinct non interactive argument” in a proof system with perfect completeness and computational soundness.

When knowledge is also involved, instead one has a “succinct non interactive argument of knowledge”; the acronym used is SNARK, and the proof system is said to have perfect completeness and computational knowledge soundness. In this kind of proof system, a verifier can convince himself that a proof is valid, but the verifier cannot confirm the type of knowledge. Computationally knowledge soundness is stronger than computational soundness because the verifier can convince himself that the prover actual knows a valid witness w.

### Zero-Knowledge

Finally, there is zero-knowledge (ZK), when the verifier, being able to convince himself that the prover knows the witness w, cannot learn anything about w (ZK-proof). The class of statements for which is possible to develop a ZK-proof is mathematically defined as the complexity class Nondeterministic Polynomial-Time (NP). In the NP class if the answer is “yes” then there is a proof of the fact, otherwise the algorithm must declare invalid any purported proof that the answer is “yes” (PCP Theorem, see “The Knowledge Complexity of Interactive Proof Systems”, by Goldwasser et al.).

Some zero-knowledge systems may require the role of the creator, a person or a group, who sets up the system deciding first of all what the system is designed to prove. In these systems it is paramount that the creator behaves honestly by keeping secret forever or even destroying the initial randomness that must be generated for the trusted setup, this for avoiding the misbehaving person forging proofs. For example, the ZK system implemented in ZCash (zk-SNARK), which is a ZK-proof system that includes the role of the creator, required a public and very visible ceremony to demonstrate that the randomness used for the trusted setup is forever destroyed.

### Zero-Knowledge Proof of Biometric Matching

A solution not requiring a role of a creator was shown in a paper published in Mar. 6, 2018 by Eli Ben-Sasson et al. titled “Scalable, transparent, and post-quantum secure computational integrity”. The paper describes a proof system based on zero-knowledge scalable transparent arguments of knowledge (zk-STARK). This proof system does not require a trusted setup. Notably, the use case of the paper is a zero-knowledge proof of the DNA profile match (DPM) of an individual that is executed on the forensic DNA database of the police without actual disclosure to third parties, besides the police, of any medical or forensic data. However, this is different from the present invention in which the DNA data for executing a DPM is masked to any third party except the individual owning the encryption key used to protect the identifiable information, eliminating the need of a trusted third party.

In the present invention the wallet owner would have posted at previous time t on a blockchain a hidden commitment, tracked by an ensemble identifier, of data corresponding to a measurement of his DNA profile (for example the profile taken using the Combined DNA Index System), the data being cryptographically masked. Later on, in the matching phase, a new commitment p is posted by the wallet owner on the blockchain of a new measurement again cryptographically masked using a private key controlled by him. The matching can produce only one of three possibilities: “no match”, “partial match” or “full match”. The parties are the wallet owner as the prover and a verifier, and one of the three possible outcomes is chosen for testing. A public open-sourced code (whose content might have been audited and trusted) is used for executing a privacy preserving computation in one of the aforementioned forms. The code is run using encrypted data t and p with the condition that a successful termination is exclusively given if the desired outcome is returned by the computation.

### Computation on a Blockchain

A computation can also run directly on a blockchain; the code that may run on a blockchain is termed smart contract. Since smart contracts have the property of being self-verifying and self-executing, they are considered to be tamper-proof. In an embodiment of the present invention, a smart contract executes the biometric matching. For this, it is required that data needed for the program execution (i.e. the biometric template) are also stored in a masked form on the blockchain itself due to limitations imposed by the consensus protocols forbidding the access to off-chain data.

If the computation is executed externally to the blockchain, there is the need of a protocol combining internal (on-chain) and external (off-chain) computation. The Origo protocol (see https://origo.network/whitepaper) for example, provides an integration between on-chain and off-chain processes for privacy preserving computation where the off-chain part returns zk-proofs of execution. Instead, examples of integration among on-chain and off-chain for privacy preserving computation based on TEE are shown by Enigma (https://enigma.co) or Oasis Labs (https://www.oasislabs.com).

The component providing a functionality of connection between a blockchain and the external world is termed an oracle. If an oracle is centralized, it represents a single point of failure. A decentralized oracle network can instead complement the inherent robustness and tamper resistance of a blockchain (see “ChainLink A Decentralized Oracle Network” of Steve Ellis et al.). In ChainLink, there are two different type of smart contracts inter-operating on a blockchain, the user smart contract USER-SC transacting on chain with the ChainLink smart contract CHAINLINK-SC. CHAINLINK-SC accept request from USER-SC and return externally gathered data.

In the preferred embodiment of the present invention, the privacy preserving calculation is executed by a decentralized oracle network inter-operating with a non-permissioned blockchain. In another embodiment of the present invention, in which regulatory constraints impose strict requirements independently from costs of resources, the privacy preserving calculation is executed inside a smart contract of a permissioned blockchain.

### Operation of the Present Invention

The core of the present invention is a wallet similar in part to a traditional wallet allowing a user to manage transactions on a blockchain. Besides having some similarities and commonalties, the wallet of the present invention differs by having additional functionalities:

1. The wallet is also able to exchange messages with other users, the messages can have attachments (the data) (think for example of WhatsApp).

2. The wallet is able to acquire biometric measurements from users.

3. The wallet is able to generate ensembles identifiers and store data in accordance with preferences of users, for example differentiating the repository of anonymous data from the repository of PII and QI.

4. The wallet may also allow the user to manage the inventory of ensemble identifiers performing operations such as labeling, listing, inserting, deleting, reordering, etc.

5. The wallet is able to generate and commit in a blockchain the ensemble identifiers.

6. The wallet is able to provide a zero-knowledge proof of the reveal step related to an ensemble identifier without compromising the secret.

7. The wallet is able to de-anonymize anonymous data by allowing the owner to perform a biometric matching against an encrypted biometric template associated to an ensemble identifier. More precisely it is able to send a zero-knowledge proof of the positive biometric matching.

Assuming two individuals, the prover and the verifier, both having a device running the wallet of the present invention, an exemplary high-level scenario of an interaction (based on a use case in the health industry) between a patient (the prover) and a doctor (the verifier) may comprise these steps:

1. The patient initially performs a medical test. The result is anonymized and stored safely by a data-custodian returning the URI of an anonymized record of the test back to the patient.

2. Optionally a hash of the data may be stored on a blockchain by the data-custodian for archiving purposes and double checking, but must be limited only to the anonymized part of the data.

3. The data-custodian may be an entity that is using the anonymous data for secondary purposes; for example it could be training a deep learning model for research, and since the data has been anonymized, it is now useable in this manner.

4. The patient stores on the blockchain an ensemble identifier of the anonymized data in combination with his biometric template, the biometric template being masked by encryption. The encrypted biometric template can be stored on the same repository or on a different one (it makes no difference; it is not a PII anymore).

5. The patient contacts the doctor and transmits the medical test, now anonymized, to him through the wallet. Notably the patient can also simply share a URL pointing at the medical test.

6. If the doctor needs a positive identification of the patient for assessing the correct ownership of the medical record, he can ask to perform the biometric matching to the patient and receive a zero-knowledge proof that is also stored in blockchain.

7. The biometric matching is performed as a privacy preserving calculation, without the doctor having access to real biometric data of the patient. The result is provided by patient to the designated verifier (the doctor) in a note, so the result is only known to these two subjects. A different use case requiring that the result is publicly verifiable is equally possible. Notably, the biometric matching can be performed either on the patient device or on the doctor device.

In an embodiment of the present invention, the result is a zk-proof transmitted in a note to the verifier, and known only to him (other than the wallet owner). In the entire process, there is no disclosure of biometric data to anyone; the outcome is entirely confidential exclusively to the advantage the intended parties. Furthermore, in the present invention, the computational soundness is supported by the biometric identification and the blockchain; the likelihood of acceptance of an invalid proof is very significantly decreased. Notably, even a stolen viewing key would not allow an attacker to impersonate another individual, because it is extremely unlikely that the attacker would be able to match the biometric identification. Data related to a note remains anonymous until a confidential disclosure is made by the wallet owner to someone else, and additional claims such as ownership can be provided through biometric positive identification.

Several descriptions and illustrations have been presented to aid in understanding the present invention. One with skill in the art will realize that numerous changes and variations may be made without departing from the spirit of the invention. Each of these changes and variations is within the scope of the present invention.

I claim:

1. A method for supplying data relating to an individual that can be proved to be connected to the individual using a biometric template such that others may access the data without being able to identify the individual or access the biometric template comprising:
enrolling the individual by creating a positive biometric identification of the individual that includes the biometric template of the individual encrypted and masked to others, said biometric template being solely controlled by the individual;
providing a hash to reference the biometric template by obtaining the hash through a one-way pre-image resistant cryptographic function, said hash being immutably stored into a trustless decentralized ledger distributed multiple times to a plurality of nodes exchanging consensus over a blockchain;
anonymizing a set of data relating to said individual to produce an anonymized data set;
associating the anoymized data set with the encryped biometric template and the hash;
allowing a third party access to the anoymized data set;
providing identity proof of the anonymized data set by the individual by providing biometric matching proved through a privacy preserving calculation without disclosing contents of the biometric template to the third party.

2. The method of claim 1, wherein the hash of the biometric template is combined into an ensemble, said ensemble referenced by a master hash and comprising a hash list, the hash list including one or more hashes pertaining to the anonymized data set, the master hash immutably stored in the blockchain;

3. The method of claim 1, wherein the anonymized data set is stored by a data custodian outside the blockchain.

4. The method of claim 3, wherein the data custodian uses the data for secondary purposes.

4. The method of claim 1, wherein the privacy preserving calculation is executed using a plurality of nodes that is different from the nodes exchanging consensus on the permissionless blockchain.

5. The method of claim 4, wherein the privacy preserving calculation comprises a commit-reveal scheme.

6. The method of claim 1, wherein the individual is able to de anonymize the data.

7. The system of claim 1, wherein the biometric matching is proved by the individual by committing a non-interactive argument to the blockchain; said proof being certified by a verifier.

8. The system of claim 1, wherein the biometric matching is proved by the individual by executing the privacy preserving calculation in a trusted execution environment using homorphic encryption.

9. The system of claim 1, wherein the blockchain is a permissioned blockchain.

10. A method for supplying data relating to an individual that can be proved to be connected to the individual using a biometric template such that others may access the data without being able to identify the individual or access the biometric template comprising:
enrolling the individual by creating a positive biometric identification of the individual that includes the biometric template of the individual encrypted and masked to others, said biometric template being solely controlled by the individual;
providing a hash to reference the biometric template by obtaining the hash through a one-way pre-image resistant cryptographic function, said hash being immutably stored into a trustless decentralized ledger distributed multiple times to a plurality of nodes exchanging consensus over a blockchain;
combining the hash of the biometric template into an ensemble, said ensemble referenced by a master hash and comprising a hash list, the hash list including one or more hashes pertaining to the anonymized data set, the master hash immutably stored in the blockchain;
anonymizing a set of data relating to said individual to produce an anonymized data set;
associating the anoymized data set with the encryped biometric template and the hash;
allowing a third party access to the anoymized data set;
providing identity proof of the anonymized data set by the individual by providing biometric matching proved through a privacy preserving calculation without disclosing contents of the biometric template to the third party.

11. The method of claim 10, wherein the privacy preserving calculation is executed using a plurality of nodes that is different from the nodes exchanging consensus on the permissionless blockchain.

12. The method of claim 11, wherein the privacy preserving calculation comprises a commit-reveal scheme.

13. The system of claim 12, wherein the blockchain is a permissioned blockchain.

14. A method for supplying data relating to an individual that can be proved to be connected to the individual using a biometric template such that others may access the data without being able to identify the individual or access the biometric template comprising:
enrolling the individual by creating a positive biometric identification of the individual that includes the biometric template of the individual encrypted and masked to others, said biometric template being solely controlled by the individual;
providing a hash to reference the biometric template by obtaining the hash through a one-way pre-image resistant cryptographic function, said hash being immutably stored into a trustless decentralized ledger distributed multiple times to a plurality of nodes exchanging consensus over a blockchain, wherein the blockchain is a permissioned blockchain;
anonymizing a set of data relating to said individual to produce an anonymized data set;
associating the anoymized data set with the encryped biometric template and the hash;
allowing a third party access to the anoymized data set;
providing identity proof of the anonymized data set by the individual by providing biometric matching proved through a privacy preserving calculation without disclosing contents of the biometric template to the third party.
